(19) United States
(12) Patent Application Publication
(10) Pub. No.: US 2026/0307723 A1
(43) Pub. Date: Oct. 8, 2026

(54) BRAKED SLIDING SIDEWALL AND DOOR

(71) Applicant: Gyozo KEINDL, Vertesszolos (HU)

(72) Inventor: Gyozo KEINDL, Vertesszolos (HU)

(21) Appl. No.: 19/481,654

(22) PCT Filed: May 3, 2024
(86) PCT No.: PCT/HU2024/000002

§ 371 Date: Nov. 5, 2025

(30) Foreign Application Priority Data
May 5, 2023 (HU) P2300147

(51) Int. Cl. B62D 21/15; B60J 5/04; B62D 25/02

(52) U.S. Cl. CPC B62D 21/157; B60J 5/0412; B60J 5/0433; B62D 25/02

(57) ABSTRACT

A vehicle sidewall or door designed to protect against intruding structural elements during a collision, comprising a braked-sliding, chain-guided, truss force transmission system in the central belt line with crumple element and swinging ribs, including: ·a truss (1) welded from below to a hinged massive window frame, ·three pairs of hinged structures (2a, 2b, 2c) connected to the bottom of the truss (1), ·three swinging ribs (3a, 3b, 3c) hanging from the hinged structures (2a, 2b, 2c), where, in the event of accidental collisions, these hanging swinging ribs (3a,b,c) can move due to the deformation resistance of a sized external (5a, 5b) and internal (6a, 6b) crumple element guided by a guide chain (4) that also moves, thereby realizing the braked sliding passive protection system, where the braked sliding occurs by a measured, decelerating change of direction controlled by chains (4), wherein the crumple zone is formed to a maximum depth (8b) and height (8a) by plates of maximum 1.2 mm thickness, so that the intruding elements can continue under the leg.

### SUBJECT MATTER OF THE INVENTION

The subject matter of the invention is a vehicle sidewall or door designed to protect against intruding structural elements during a collision in the event of a car accident, providing protection against neck and head injuries caused by seatbelt jerks and protecting the legs.

This is achieved by comprising a braked-sliding, chain-guided, truss force transmission system in the central belt line with crumple element and swinging ribs, the elements of which are as follows:
a truss (1) welded from below to a hinged massive window frame,
three pairs of hinged structures (2a, 2b, 2c) connected to the bottom of the truss (1),
three swinging ribs (3a, 3b, 3c) hanging from the hinged structures (2a, 2b, 2c),
   where, in the event of accidental collisions, these hanging swinging ribs (3a,b,c) can move due to the deformation resistance of a sized external (5a, 5b) and internal (6a, 6b) crumple element guided by a guide chain (4) that also moves, thereby realizing the braked sliding passive protection system, where in the case of accidental collisions the braked sliding occurs by a measured, decelerating change of direction controlled by chains (4). The protection of the legs is realized due to its elevated position and the crumple elements guided by the chain, so that, as shown by the dotted line on FIG. 4 the crumple zone is formed to a maximum depth (8b) and height (8a) by plates of maximum 1.2 mm thickness, so that the intruding elements can continue under the leg, avoiding neck and head injuries caused by strong pulling through the belt, as well as meeting with the leg and the leg injury.

An advantageous aspect of the invention is that the truss (1) is secured at four points on the door locking mechanism, and the minimum thickness of the welded material is at least 3.4 mm. Additionally, the invention advantageously provides that the welded, dual-hinged hanging structures (2a, 2b, 2c) are equipped with additional welded reinforcement plates, with a minimum wall thickness of 4.3 mm for single-sided welding and 5.2 mm for double-sided welding. Moreover, the hanging swinging ribs (3a, 3b, 3c) are primarily designed to withstand side impacts.

Furthermore, the subject matter of the invention advantageously provides that the uppermost chain element of the guide chain (4) is equipped with a borehole, so that the crumple elements (5a, 5b, 6a, 6b) can be connected with a connecting bolt (7) (and thus it becomes the weakest chain element), made of thicker material or more alloyed steel so that they last up to the recommended lowest breaking limit value: up to 1.96 tons,

The subject matter of the invention is also advantageously to prevent movement and rattling so that, the movable swinging ribs (3a, 3b, 3c) hanging from the fixed hinged structural elements (2a,b,c) hanging from force transmitting truss and the and the moveable dimensioned chain (4) is wedged with a dimensioned plastic fastening element or preferably with a rubber wedge, fixed and/or fixed with screws, rivets and/or fixed with glue, preferably with silicone-based glue, in such a way that the movement is not hindered by the fixing.

Area of application: The subject matter of the invention can be applied in an area where the human body is exposed to injury caused by collision or impact, and it is necessary to slow down or avoid impact in a controlled way, such as in the storage and transport equipment of explosive materials and structures, as well as in cars and all other vehicles, where there is a risk of collision.

### STATE OF THE ART

The fundamental construction principles of modern vehicles regarding passive safety were established by Béla Barényi at Mercedes (Daimler-Benz), a Hungarian born constructor around the 1970s. The essence of the solution was a triple tiered structure in the case of passenger cars: deformable crumple zone,—massive passenger cell,—deformable crumple zone.

However, at higher speeds, these crumple zones often fail to provide adequate protection, because in the case of a more powerful or lateral, half-side collision, the penetrating components and structural elements of the colliding vehicles reach each other's massive passenger compartment, where they can still inflict a fatal blow on the human body through the belt (neck and rib fractures, rupture of internal organs), and the intruding structural elements can also cause serious leg injuries. In the event of a side collision, mainly chassis elements—in the most common case the McPherson chassis—intrude into the passenger compartment: both the vehicle's own chassis element pushed back and the intruding chassis element of the other party.

### Objective of the Invention

To eliminate this, it would be desirable to have a solution that brakes the intruding structural elements in a controlled manner, while avoiding collisions with the human body, it does not significantly hinder their moving further on, in contrast to the longitudinal bracings exposed to the wind according to the state of the art, but slides the intruding elements away without hindrance and slows down, leads them out, leads them through while also ensuring leg protection.

### Solution of the Invention

Based on the solution according to the invention, the intruding structural elements pass under the feet elevated by the footrest, as it appears from the dimensions of the outlet zone indicated by the dotted line in FIG. 4.

The subject matter of the invention is that passive protection is achieved in one system that, contrary to the state of the art, provides protection in the event of a collision from all directions.

Since the solution according to the invention does not include a bottom, reinforced sill on the edge, as a longitudinal support, nor its cross-stiffened supports, the chassis elements intruding from the front or from the side are able to continue their path towards the door-moving backwards.

There, the swinging ribs hanging from the force transmitting truss under the window (FIGS. 2-1) are pushed backwards due to the counteraction of crumple elements (with controlled deceleration), thereby realizing the principle of braked-sliding. The connections of the system are ensured by welded two-axis hinges and bolt-fasteners. The backward movement is controlled by chains.

The essence of the invention is the implementation of three-dimensional, controlled braked sliding.

### Comparative Table of the Solutions According to the Subject Matter of the Invention of the State of the Art

| STATE-OF-THE-ART SOLUTION | CHAIN GUIDED, BRAKED-SLIDING |
|---|---|
| WITH REINFORCED SILL, AND | SOLUTON ACCORDING TO THE |
| CROSS-STIFFENED SUPPORTS | INVENTION |
| 1. Fix collision force transmission; | 1. Only middle and upper fixed force |
| Lower reinforced sill, mid-level belt line | transmission; The lower section utilizes a |
| window-bottom reinforcements, and | movable, chain-guided force |
| upper roof longitudinal reinforcements | transmission, implementing the braked- |
| with force transmission. | sliding concept. |
| 2. Rigid Longitudinal (or Diagonal, but | 2. Movable braces in the door (no jerking |
| rigid) reinforcements in the door | occurs, there is only controlled |
| facilitating seatbelt jerks during | deceleration) |
| collision. | |
| 3. Limited protection against seatbelt, | 3. Comprehensive protection against jerks |
| neck and head jerks. | from all angles, from the front, sides, and |
| Provides protection only from frontal | back, due to the 50-70 cm crumple zone |
| impacts, belt, neck and head jerks up to | and the upward sliding angle provided by |
| the front reinforcement of the safety | the swinging ribs, extending to the bottom |
| passenger cell and from rear impacts up | of the dotted line in FIG. 4. Therefore, |
| to the rear reinforcement of the safety | no sideways jerks or head injuries occur. |
| passenger cell. No protection from side | |
| or rear impacts due to the rigid sill, | |
| leading to immediate injury without a | |
| crumple zone. | |
| 4. Vulnerability of legs to intruding | 4. Leg protection with elevated footrests; |
| structural elements: The reinforced sill | The elevated leg according to the |
| solution does not protect the legs from | invention provides protection because the |
| intruding front cross-brace. | intruding elements pass underneath the |
| | legs, thus safeguarding the feet and legs. |

### Advantageous Examples Embodiment and Solutions

1. Advantageous embodiment for the Rearview Mirror: It is beneficial to weld the rearview mirror's bold-on mounting housing from aluminum, as it becomes part of the crumple zone in case of a rollover. Every bit count, contributing an additional 15-20 cm outwards.
2. Hinge Design embodiment:
   It is advantageous, if the two lower fit on the receiving hinge pin, while the upper hinge should be mounted in a reverse configuration to prevent disengagement. The hinges are connected to the frame with short flat iron stems, allowing the frame to be easily wrapped with a sheet cover from all four sides (see FIG. 9).
3. External Panel Design: An advantageous embodiment for the door's external panel is a simple box structure. Only the upper four corners are welded, as it is necessary to functionally separate the upper part from the lower part. The lower sliding zone must be able to move easily or open smoothly. According to an advantageous embodiment the door panel consists of four elements. An internal panel of maximum 1.2 mm, an upper external panel of 3 mm, a lower external panel of maximum 1.2 mm, and a lower panel of maximum 1.2 mm thickness. The recommended material is stainless steel plate, using stainless steel bolt-fasteners (flanged, d-head, hexagon socket type embodiment being one of the best). The upper external panel (3 mm) does not need to be flanged back at the window frame as it is sufficiently rigid.
   The lines numbered 8 in FIG. 5 show the lower edge of the upper part.
4. Recommended advantageous embodiment for lower window is to screw the window into the frame instead of gluing it. The window material should preferably be UV-resistant polycarbonate sheet.
5. An advantageous example embodiment of upper glazing:
   Due to the structure's design, the window glass CANNOT be lowered.
   FIGS. 2, 5, and 14 illustrate a preferred sliding window design, but it can also be a pivoting window that tilts up and down. The side window of the CITROEN 2CV “duck” or certain solutions in American RV-s are good examples of this solution.
   The front and rear sealed channels of sliding window—the u-profile rail into which it is fixed and can be slid—are equipped with drainage taps at the front and rear at the bottom, with small, welded tubes attached to them. to which a rubber tube is connected from the bottom, leading the potential rainwater, wash water, or condensation through the lower door panel (as shown in FIGS. 11 and 12).
6. Another preferred embodiment of the upper glazing:
   The outer window channel is securely bolted to the reinforced, covered window frame (around the perimeter) with sealing silicone glue. At the front the inner window channel (since the window must also function as an emergency exit) can be turned inwards from the vertical plane of the window frame. At the rear, it can be turned out around a fixed pin equipped with a water drainage hole, nuts, spring washers, and plain washers. The lower pin equipped with water drainage hole and the upper pin bolt form the pivot axis. At the front after tilting the spring-loaded, rubber-sealed end caps of the channel, the glass can be pushed forward, folded up, and removed, allowing for easy escape (e.g., in the event of a rollover). To pivot the inner glass from its base position, the drainage rubber tube at the front must be left longer (cut to size).
   Fixing the inner channel:
   The inner channel is secured by a flat metal piece with a hole welded to the front of the channel, which is manually bolted with a wing nut screw to the inner edge of the window frame, but first, the foam-padded artificial leather trim, which is fixed at the top with small pins, is folded down.
   The material, shape, size, and design of the various components can be selected advantageously in accordance with the requirements.
   As preferable example embodiment flexible, unbreakable plastic elements can be used instead of rubber springs in off-road strollers or child transport bicycle trailers.
   As preferable example embodiment able in space shuttles, or in their safety return capsules, titanium alloys can be used.
   Preferably as crumple element a dimensioned denting sheet element, a spring, or even a rubber ball can be used.
   The invention is not limited to the preferred embodiments, the scope of protection extends to the embodiment of the principle of the solution according to the invention.

### FIGURES AND THEIR DESCRIPTIONS

The figures of the application provide further assistance in understanding the embodiments of the invention and their contextual relationships. This makes the concept easily comprehensible, and the advantages of the embodiments more interpretable. The figures are not to scale, and their positions are described according to their placement within the vehicle.

FIG. 1: Illustrates the structure of a conventional self-supporting framed passenger car belonging to the current state of the art (with a McPherson front suspension), where the arrows indicate the force impacts during a collision and the possible directions of movements.

FIG. 2: Shows a drawing of a car equipped with the braked sliding door according to the subject matter of the invention, according to one of the preferred embodiments of the invention.

FIG. 3: The conventional self-supporting structured passenger cell belonging to the current state of the art, where the cross-sections of the car's longitudinal reinforcements are indicated by dashed lines, marking the bumper height of an average car from the side (45-65 cm).

FIG. 4: Shows the structure of the braked sliding car door according to the invention from the front, showing the receiving frame structure and its exit zone (9, dotted line).

FIG. 5: Illustrates the lower structure of the braked sliding car door according to one preferred embodiment of the invention (side view), clearly showing the connection the bottom of the hanging swinging ribs (3a, 3b, 3c) with the guide chain (4), and with the crumple elements, marking the upper (8a) and lower (8b) boundaries of the external plate covering elements. In one advantageous solution, the uppermost chain link of the guide chain (4) is provided with a hole, thus providing the possibility of connection with a connecting bolt (7).

FIG. 6: Presents a cross-section of a simple riveted floor with double rubber sealing and a protective tread plate according to a possible preferred embodiment of the invention.

FIG. 7: Shows the braked sliding car door according to the invention from the front, illustrating the position of the handle mechanism, the positions of the upholstery, and the position of the swinging rib and guide chain according to a possible preferred embodiment of the invention.

FIG. 8: Depicts the force-transmitting truss of the braked sliding car door according to one preferred embodiment of the invention, clearly showing the four-point locking latch mechanism with disc-controlled rods and counter-spring structural solution.

FIG. 9: Illustrates the possibility of enclosing the hinge with plate according to one of the advantageous example embodiments of the braked sliding car door according to the invention.

FIG. 10: One of the preferred embodiments of the braked sliding car door according to the invention the two-axis solution of the hanging swinging rib welded to the force-transmitting truss is shown.

FIG. 11: Displays the lower plate cover of the braked sliding car door in perspective view with water drainage openings and water drainage pipes according to a preferred embodiment of the invention.

FIG. 12: Provides a lateral view of the element depicted in FIG. 11.

FIG. 13: Illustrates in perspective view the position of the braked sliding car door according to the invention, marked with thick dashed lines, indicating the position of its pivot axis according to a preferred, simplest embodiment as well as the surroundings of the door and the higher, protected seating position.

FIG. 14: Demonstrates in side view the braked sliding car door according to the invention in its basic position and during a possible movement also showing the with arrows the downward sliding and the smooth upward sliding directions that do not cause jamming, in the preferred embodiment of the invention.

FIG. 15; Shows the braked sliding car door in front view during a side collision, according to a preferred embodiment, where the arrows indicate the pleasant non-jamming directions of downward sliding and upward sliding over.

### ADVANTAGES OF THE INVENTION

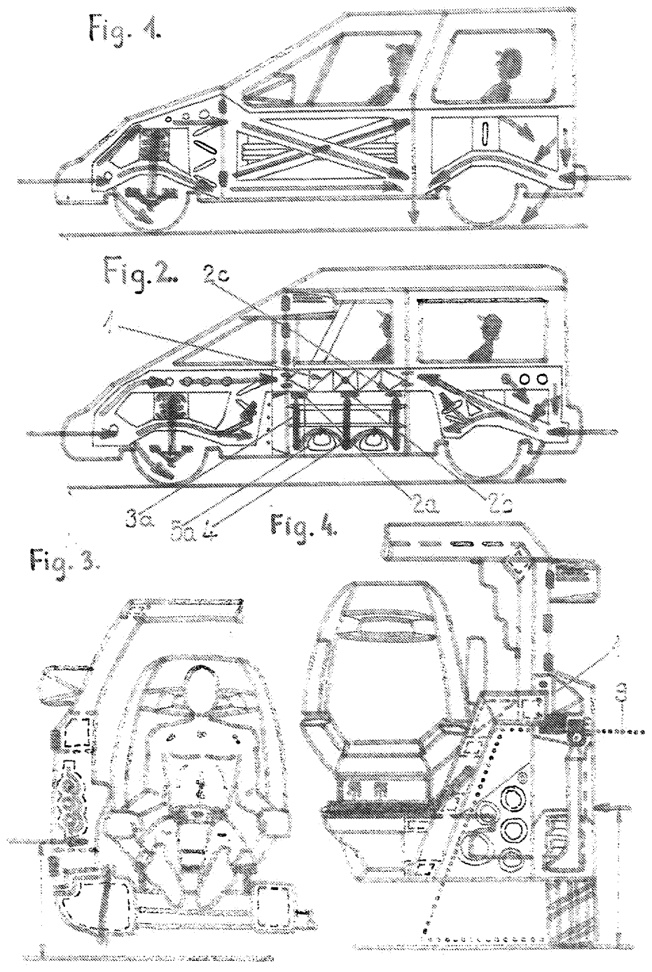

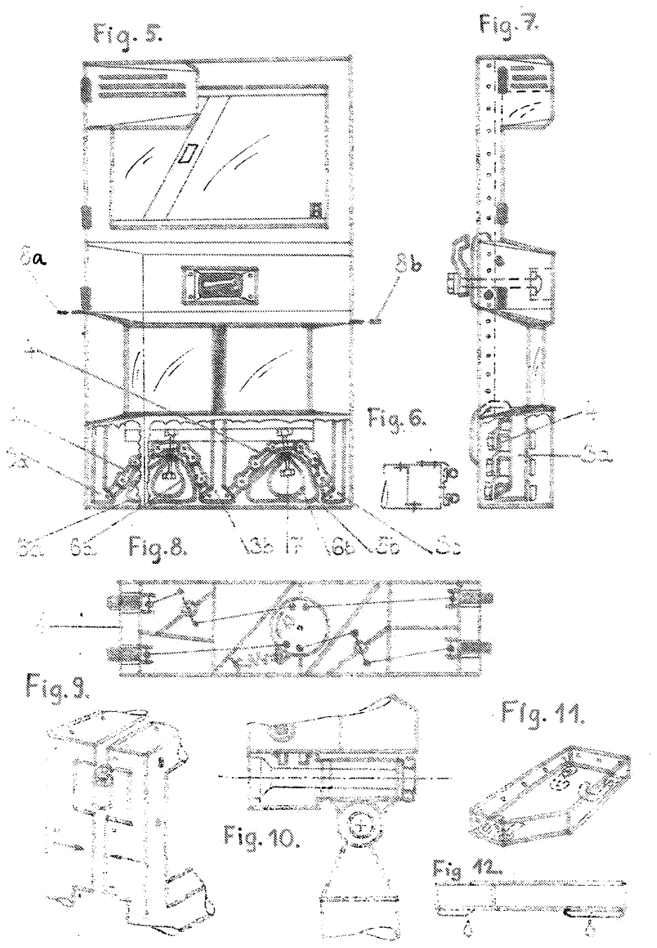

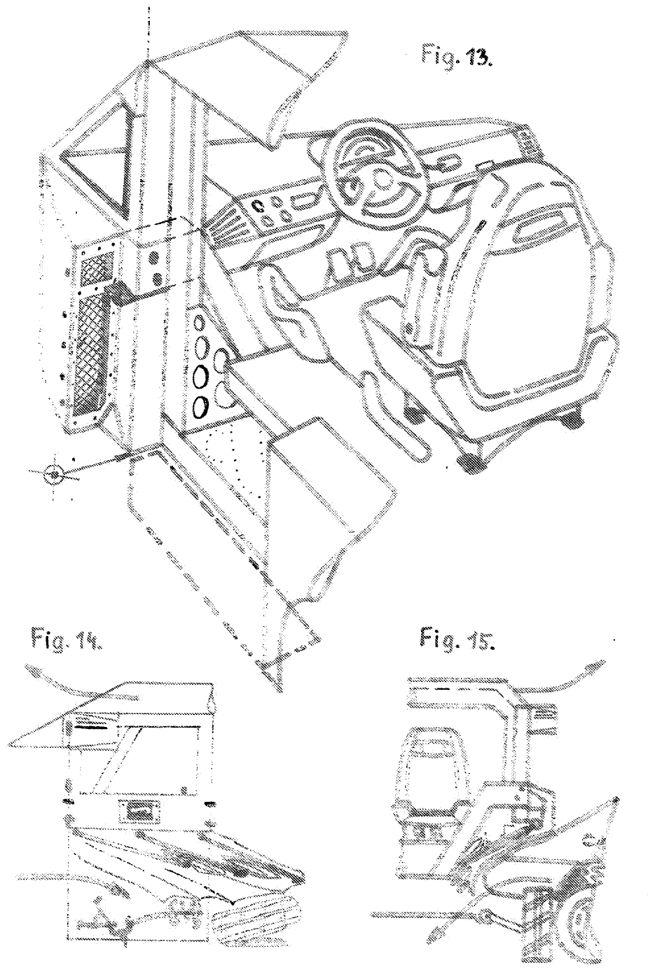

1. The brake-sliding system according to the invention can reduce road fatalities to below 1%, even in high-speed collisions. With the reinforced sill solution of the state of art, this rate is significantly higher due to edge-based reinforcements (as shown in FIG. 3). Moreover, additional longitudinal tube reinforcements are installed in the doors to prevent compression.
2. The systems related to the state of art are not safe, especially in the case of lightweight vehicles (e.g., microcars).
3. The brake-sliding system according to the invention offers greater safety, as evidenced by statistical data.

LIST OF REFERENCE NUMBERS

| | |
|---|---|
| 1 | force-transmitting truss |
| 2a, 2b, 2c | hinged structures for hanging |
| 3a, 3b, 3c | hanging swinging ribs |
| 4 | guiding chains |
| 5a, 5b | external crumple element |
| 6a, 6b | internal crumple element |
| 7 | connecting bolt |
| 8a | maximum height of the external plate covering elements: |
| | upper boundary line |
| 8b | depth of the external plate covering elements: lower |
| | boundary line |
| 9 | exit zone |

1. Vehicle sidewall designed to protect against intruding structural elements during a collision in the event of a car accident, providing protection against neck and head injuries caused by seatbelt jerks and protecting legs comprising a braked-sliding, chain-guided, truss force transmission system in central belt line with external and internal crumple elements guided by a guide chain and swinging ribs, the elements of which are as follows:
a truss (1) welded from below to a hinged massive window frame,
three pairs of hinged structures (2a, 2b, 2c) connected to bottom of the truss (1), and
three swinging ribs (3a, 3b, 3c) hanging from said hinged structures (2a, 2b, 2c), where, in the event of accidental collisions, said swinging ribs (3a,b,c) move due to the deformation resistance of said chain-guided external (5a, 5b) and internal (6a, 6b) crumple elements guided by said guide chain, thereby realizing a braked sliding passive protection system, braked sliding occurring by a measured, decelerating change of direction controlled by said guide chain.

2. Vehicle sidewall according to claim 1 characterized by that the truss (1) is secured at four points on a door locking mechanism, and minimum thickness of welded material is at least 3.4 mm.

3. Vehicle sidewall according to claim 1 characterized by that the hinged structures (2a, 2b, 2c) are equipped with welded reinforcement plates, with a minimum wall thickness of 4.3 mm for single-sided welding and 5.2 mm for double-sided welding.

4. Vehicle sidewall according to claim 1 characterized by that the swinging ribs (3a, 3b, 3c) are primarily designed to withstand side impacts.

5. Vehicle sidewall according to claim 1 characterized by that an uppermost chain element of the guide chain (4) is equipped with a borehole, so that said crumple elements (5a, 5b, 6a, 6b) can be connected with a connecting bolt (7) made of thicker material or more alloyed steel so that they last up to the recommended lowest breaking limit value: up to 1.96 tons,

6. Vehicle sidewall according to claim 1 wherein the swinging ribs (3a, 3b, 3c) hanging from the fixed hinged structural elements (2a,b,c) and the guide chain are wedged with a dimensioned plastic fastening element sufficient to prevent movement and rattling.
